(19) United States
(12) Patent Application Publication
(10) Pub. No.: US 2003/0226431 A1
(43) Pub. Date: Dec. 11, 2003

(54) Paper perforation system

(76) Inventor: Marcel Motard, Laval (CA)

Correspondence Address: BIRCH STEWART KOLASCH & BIRCH, PO BOX 747, FALLS CHURCH, VA, 22040-0747, US

(21) Appl. No.: 10/162,403

(22) Filed: Jun. 5, 2002

(51) Int. Cl. B26D 1/00; B26D 3/00

(52) U.S. Cl. 83/13; 83/660

(57) ABSTRACT

A perforation forming apparatus for a web fed paper processor generally comprising a perforator cylinder and an anvil cylinder. The rotatable perforator has at least a blade protruding radially from the cylinder. The rotatable anvil cylinder is adjacent the perforator cylinder and is contiguously engageable therewith. One of the perforator cylinder and the anvil cylinder is supported by eccentric bearing assemblies, comprising fluid cooled bearings eccentrically mounted in bearing housings and therefore adapted for rotation such that the eccentrically mounted cylinder can be pivotally displaced between a first and second position. Whereby pivoting to the second position during operation temporarily suspends perforation of the paper web, and returning to the first position during operation resumes perforation of the paper web.

### TECHNICAL FIELD

The present invention relates generally to a perforation forming system of a printing press, and more particularly to a perforation forming system having a perforator cylinder that can be disengaged and precisely re-engaged with a mating anvil cylinder during press operation.

### BACKGROUND OF THE INVENTION

Offset printing presses are well known in the art, as are various types of perforation systems employed in printing presses to produce transverse perforations in a continuous paper web. For certain applications, it is desirable to be able to temporarily suspend the perforation of the web without requiring the entire press to be stopped and then be able to accurately re-start the web perforation, all at press full operating speed.

U.S. Pat. No. 5,048,387 issued Sep. 17, 1991 to Niitsuma et al. discloses a horizontal perforation forming apparatus for a rotary press which includes an interaxial distance adjusting unit for adjusting the distance between the axes of a perforation cylinder and a mating cylinder. The interaxial distance adjusting means has eccentrically mounted roller bearings rotatably supporting the perforation cylinder and the mating cylinder, such that the distance adjusting means rotates both the first and second eccentric bearing housings to provide adjustment of the distance between the cylinders. The perforation system used by Niitsuma et al. is of a male/female type, wherein the axial blades protruding from the outer surface of the perforation cylinder mate with blade seats in blade receiving grooves extending in the axial direction of the mating cylinder. As there is a certain amount of penetration of the blades into the blade seats, bearing tolerances are less important in order to ensure complete perforation of the paper web. However, as the blades of the perforation cylinder and the blade seats of the mating cylinder must align perfectly, circumferential timing is of prime importance.

Perforation systems which alternately employ a perforation cylinder with blades that hit a hardened solid anvil cylinder, require much greater bearing tolerances in order to ensure that the gap between the blade and the anvil is exact. The blade must pass completely through the paper web in order to create an acceptable perforation. However, too deep a cut will result in a web break, and too shallow a cut will result in a final product rejection for insufficient perforation. Regular roller bearings such as those used by Niitsuma et al. always have approximately 0.001 inch of internal clearance, and therefore the total play between the two perforation cylinders could be as much as about 0.002 inches. For a common paper web of about 0.003 inches, this could result in two-thirds of the web material not being perforated.

A solution to this problem is to use pre-loaded roller bearings, which have no internal clearance and therefore do not cause unacceptable play in the distance between the blades and the anvil cylinder. However, as a result of their pre-load they create significantly more rolling resistance, and as such generate much more heat at high speeds. This extra heat generated by the bearings can make the supporting frame expand, changing the distance between the cylinders which will also result in an unacceptable product. Some attempts have been made to eliminate the thermal expansion of the frame caused by heat generated by the bearings, by, for example, pre-heating the entire frame supporting the perforation assembly. This is impractical, and both time and cost inefficient.

Certain printing applications are also more demanding than others in terms of perforation requirements. In equipment for commercial web printing, for example, perforation is often considered as an optional extra, but is not the feature of primary import. For business form applications, in contrast, accurate through-perforation is of vital importance, as the perforation is used as the base for the registration of all other press operations, such as printing and punching.

U.S. Pat. No. 4,793,229 issued Dec. 27, 1988 to Kleber discloses a multipurpose commercial web printing apparatus for performing die cutting, perforating, embossing and scoring functions, and having a die cylinder and an anvil cylinder supported by pre-loaded tapered roller bearings in eccentric housings. The center distance between the die cylinder and the anvil cylinder is adjustable by a manually controlled micro adjustment mechanism, which requires the operator to constantly monitor the apparatus, and regularly adjust the cylinder center distance as the product gradually creeps outside of the acceptable tolerances. This micro-adjustability is intended to permit minute adjustment of the cylinder center distance when required, and is not optimized for full disengagement and re-engagement of the perforation forming cylinders. If completely disengaged, the tolerance of the die cylinder with respect to the anvil cylinder would have to be manually reset by the operator for the resumption of perforation to occur. This would be a time consuming task, required every time perforation was completely disengaged and re-engaged again. This operation would also require significant operator skill, and leaves open the possibility of operator error that could result in insufficient perforation or web break.

During web printing of products such as business forms, presses often run at high throughput speeds of as much as 1800 foot per minute. High press speeds results in high final product output, but also requires frequent blank web feed roll replacement. At these press speeds, a new feed roll is often required every twenty minutes. Splicing the start of a new roll with the existing web going through the press is well known in the art in order to avoid stopping the entire press to start the feed of the new web roll. However, this spliced web portion comprised of two layers of paper, can cause problems when it passes through a blade and anvil type perforation forming apparatus. If a perforation blade happens to strike the paper along such an overlapped spliced portion, there is a strong possibility of resulting web break.

The tension put on the paper feed roll to ensure that the web is taught and well aligned as it is fed into the press, tends to further increase the chance that a perforation occurring along the splice will cause a web break. A web break results in an entire press shutdown, and can mean a downtime of up to half-an-hour to re-spool the entire press. Such a downtime can mean significant losses for the press operator. For example, when a new paper roll is started to be rewound after perforation, the tension on the web is set as high as possible, in order to obtain a hard roll core. If the starting tension is not high enough, the center of the roll will start to slip and a roll having an axially unaligned stacking will result as the roll increases in diameter. This phenomenon is often termed roll “dish out”. The high starting tension, however, will often break the web at its weakest point, namely at the perforations. Therefore, perforations at the beginning of a new roll can often cause web breaks.

As a result, there is a need for a mating perforation and anvil cylinder type perforation forming apparatus that can be disengaged and accurately re-engaged anytime at press full operating speed, for example at the beginning and the end of a paper roll, and that does not require regular micro-adjustability and constant monitoring in order to maintain acceptable cylinder inter-axial distance tolerances.

### SUMMARY OF THE INVENTION

It is an object of the present invention to provide an improved perforation forming apparatus for a printing press.

It is another object of the present invention to provide a perforation forming apparatus that does not require constant fine adjustment of the cylinder center distance, but is capable of accurate perforation throw-off and re-engagement at full press operating speed.

It is a further object of the present invention to provide a perforation forming apparatus having a blade cylinder and a mating anvil cylinder supported by pre-loaded bearings in eccentric housings.

It is a further object of the present invention to provide a perforation forming apparatus that prevents cylinder center distance movement due to thermal expansion by having oil cooled bearings.

Therefore, in accordance with the present invention, there is provided a perforation forming apparatus for a web fed paper processor comprising: a rotatable perforator cylinder comprising a longitudinal axis, and having at least a blade protruding radially from the perforator cylinder, extending axially therealong and being substantially parallel to the longitudinal axis; a rotatable anvil cylinder being adjacent the perforator cylinder and contiguously engageable therewith, the anvil cylinder having a longitudinal axis of rotation parallel to the longitudinal axis of the perforator cylinder; one of the perforator cylinder and the anvil cylinder being supported by eccentric bearing assemblies; the eccentric bearing assemblies comprising fluid cooled bearings eccentrically mounted in bearing housings; the eccentric bearing assemblies being adapted for rotation such that the one of the perforator cylinder and the anvil cylinder can be pivotally displaced between a first and a second position; the first position defining a perforation position wherein the blade just contacts the anvil cylinder, and the second position defining a non-perforation position wherein a radial clearance gap between the blade and the anvil cylinder is at least equal to twice a thickness of a paper web adapted to be fed through the perforation forming apparatus; whereby the one of the perforator cylinder and the anvil cylinder is displaceable to the second position during operation in order to temporarily suspend perforation of the paper web, and is returnable to the first position during operation in order to resume perforation of the paper web.

There is also provided, according to the present invention, a method for controlling perforation of a paper web comprising the steps of: providing a first rotatable cylinder having a longitudinal axis and comprising at least a blade, protruding radially from an outer axially extending circumferential surface of the first cylinder and extending axially therealong; providing a second rotatable cylinder having a smooth outer axially extending circumferential surface and comprising a longitudinal axis of rotation parallel to the longitudinal axis of the first cylinder, the second cylinder being contiguously engageable with the first cylinder; providing eccentric bearing All assemblies for supporting one of the first and second cylinders, the bearing assemblies comprising fluid cooled bearings eccentrically mounted in rotatable bearing housings; displacing the one of the first and second cylinders from a first to a second position, the first position defining a perforation position wherein the blade contacts the second cylinder and the second position defining a non-perforation position wherein a radial clearance gap between the blade and the smooth outer axially extending circumferential surface of the second cylinder is at least equal to twice a thickness of the paper web; whereby displacing the one of the first and second cylinders to the second position suspends perforation of the paper web.

### BRIEF DESCRIPTION OF THE DRAWINGS

Further features and advantages of the present invention will become apparent from the following detailed description, taken in combination with the appended drawings, in which:

FIG. 1 is a side elevation view of a perforation forming apparatus according to the present invention.

FIG. 2 is a partial cross-sectional view taken along line 2-2 of FIG. 1.

FIG. 3 is an enlarged side elevation view of the perforation cylinder mounting of the perforation forming apparatus as shown in FIG. 1.

FIG. 4 is an enlarged view of the perforation cylinder bearing assemblies shown in FIG. 2.

### DETAILED DESCRIPTION OF THE PREFERRED EMBODIMENT

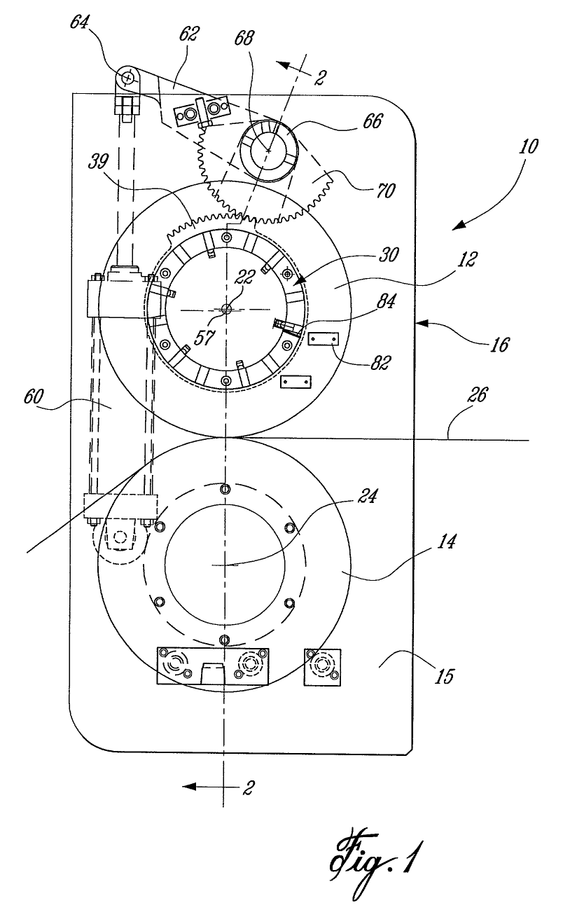

Referring to FIG. 1, a perforation forming apparatus 10 is adapted for use with a printing press, such as a web-fed offset printing press well known in the art. The perforation forming apparatus 10 generally comprises a perforation cylinder 12 and an anvil cylinder 14, each rotatably mounted between vertical main frame members 15 of the frame assembly 16, on perforation cylinder end shafts 18 and anvil cylinder end shafts 20. The shafts 18 and 20, and therefore the perforation cylinder 12 and the anvil cylinder 14, have central longitudinal axes 22 and 24, respectively, about which they rotate. The shafts can be integrally formed with the cylinder, or can be individual elements, to which the cylinder members are permanently fixed. The perforation cylinder 12 comprises a plurality of perforation blades 13 radially extending from the cylinder, and extending axially along its length. The anvil cylinder 14 is preferably a solid, hardened cylinder having a highly toleranced, smooth outer surface.

The paper web 26 enters the perforating apparatus 10 from the adjacent printing press, and is fed between the perforation and anvil cylinders. During operation of the perforating apparatus, the rotating blades of the perforation cylinder strike the paper web overlaid on the anvil cylinder, piercing the web at predetermined regular intervals. The interchangeable blades can have any one of a variety of blade profiles, such that different types of perforations can be created to suit the particular printing application.

The blades 13 are removably fastened to the cylinder 12, and can be removed for replacement, maintenance, interchanging perforation style and set-up, and the like. Preferably, a plurality of threaded fasteners are used to fix the blades 13 into axial slots in the outer surface of the perforation cylinder. This can also be used for small height adjustment of the blades, to ensure that all the blades are uniformly protruding from the cylinder, such that the blade edges are precisely and uniformly located with respect to the central longitudinal axis 22 of the perforation cylinder 12.

The perforation cylinder 12 is mounted on either end in an eccentric bearing assembly 30, generally adapted to permit the perforation cylinder to be disengaged from contact with the anvil cylinder 14 during the operation of the printing press in order to temporarily suspend the perforation of the through-going paper web 26. The eccentric bearing assembly 30 also allows accurate repositioning of the perforation roller when re-engaged with the anvil cylinder to resume perforation of the paper. Therefore, perforations can be started and stopped while the paper continues to be fed through the press and the perforating apparatus at full operating speed.

The eccentric bearing assembly preferably permits only either an on or off perforation position, and is not intended to allow running adjustment of the inter-axial distance between the perforation cylinder and the anvil cylinder. This permits a simplified perforation “throw-on/off” mechanism that, while requiring close tolerances of the cylinders, eccentric bearing assemblies and actuating mechanism, does not require a skilled operator to continuously monitor the perforation apparatus to ensure that the correct cylinder inter-axial distance is varied to maintain an acceptable perforation of the paper web.

The anvil cylinder is preferably permanently rotatably mounted in fixed bearing elements located within the frame members 15.

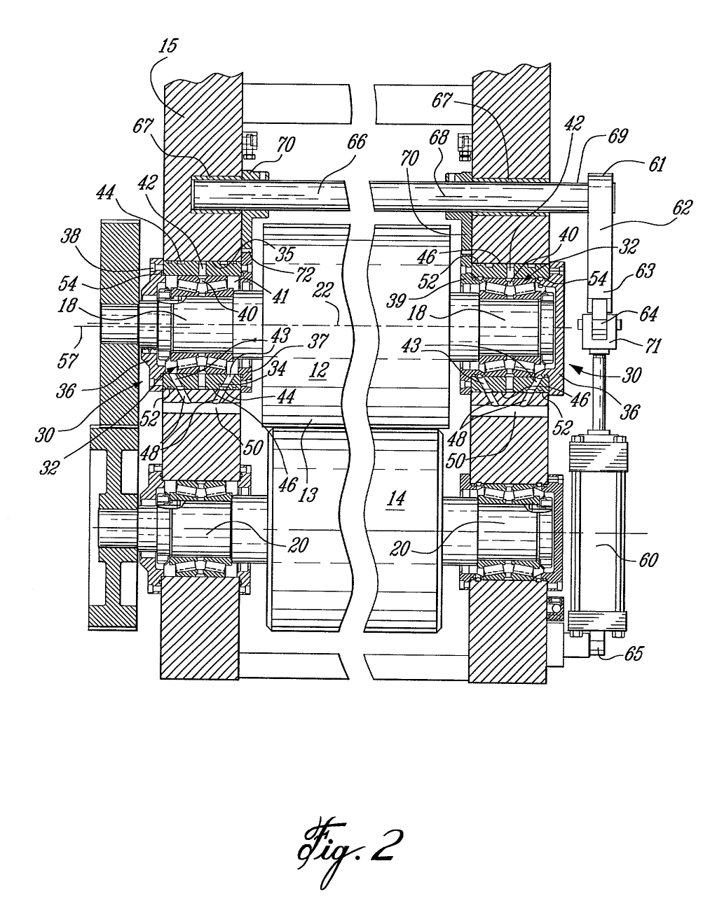

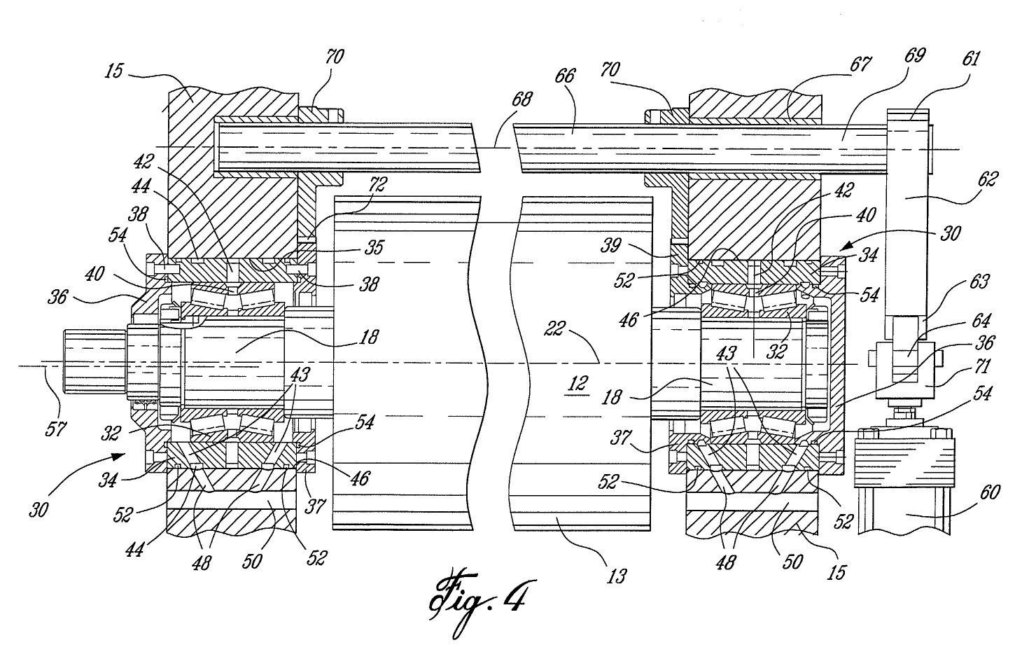

Referring to FIG. 2 and FIG. 4, the eccentric bearing assembly 30 generally comprises pre-loaded tapered roller bearings 32 eccentrically mounted in cylindrical bearing housings 34, located within holes 35 in the frame members 15 such that the bearing housings can rotate therewithin. The outer annular surface 46 of the housings 34 slides within corresponding inner annular surface of the holes 35. The outer race of each roller bearing is rotatably fixed with respect to the bearing housing, and can be engaged therewith by press fitting or other otherwise fixing to prevent relative rotation therebetween. Outer and inner axial retention plates 36 and 37 maintain the bearing housings within the frame members, prevent any axial displacement, and are engaged to the bearing housings 34 by fasteners 38, which can be pins or threaded fasteners. The retention plates therefore rotate with the bearing housings. The inner retention plates 37 comprise a toothed gear portion 39, adapted to be driven by the actuating mechanism described in further detail below, in order to rotate the entire bearing housing within the holes 35 in the frame. As the bearing 32 is eccentrically located within the housing 34, rotation of the housing about its own central axis of rotation 57 results in the vertical displacement of the central longitudinal axis 22, common to the bearings 32 and the perforation cylinder 12. In this manner, by rotating the bearing housing 34 within the frame, the perforation cylinder 12 can be raised or lowered with respect to the vertical elevation of the anvil cylinder.

Specifically, by rotating the bearing housings between two pre-determined, radially spaced positions, the perforation cylinder 12 can be moved from a position where the blades 13 of the perforation cylinder contact the anvil cylinder, to a position where the blades are raised sufficiently away from the anvil cylinder to prevent any contact with the through-running paper web. Perforation of the paper web can therefore be started and stopped during full speed operation of the printing press.

The tapered roller bearings 32 must be pre-loaded bearings. In comparison with other types of perforation systems, using a perforation cylinder and a mating hardened anvil cylinder such as is employed in the present invention necessitates close radial tolerances, and the internal clearance of the cylinder bearings is also of prime importance. Any play in one or the other cylinder can produce a gap between the perforation cylinder blades and the anvil cylinder, resulting in a final paper product that is insufficiently perforated. As the paper webs are relatively thin, even a very small play of 0.001 inch in each cylinder bearing can result in the blades only partially perforating the web. Pre-loaded bearings are used because they have substantially no internal clearance, and therefore will not cause any variations between the blades and the anvil cylinder. The side effect, however, is that they generate significant heat at high speeds, which can cause the supporting frame to expand, thereby changing the distance between the cylinders and resulting in an unacceptable final product. Therefore, to prevent such inter-axial cylinder movement due to thermal expansion, the pre-loaded bearings must be fluid cooled.

The pre-loaded tapered roller bearings 32 are preferably oil cooled, being fed oil through inlet passages 42 in the bearing housings 34, which correspond to inlet feed holes 40 in the outer race of the bearings 32. Cooling oil entering the bearings at the center thereof is dispersed axially by the rotation of the roller elements and into outer and inner annular passages 41 surrounding Art the bearing. The oil then continues to circulate under low pressure, which can be provided by a low pressure pump integral with an oil cooler for example, through passages 43 in the bearing housing 34 into circumferential annular groves 44 in the outer surface 46 of the housing. The annular grooves 44 ensure that cooling oil flow is maintained when the bearing housing 34 is rotated within the frame to engage or disengage the perforation cylinder. The grooves 44 correspond to and are in fluid flow communication with oil drain passages 48 in the frame members 15. The drain passages 48 open into larger horizontal oil outlet passages 50, also within the frame members, which can return the now heated oil to a standard oil cooler to be cooled and re-circulated. Preferably, the oil is cooled to a temperature of approximately 80° F. (26.67° C.) ±2° F. (1.11° C.) such that thermal expansion of the frame and all bearing assembly members is prevented. In order to ensure that the oil is adequately retained within the eccentric bearing assemblies 30, annular oil seal rings 52 on the inside and outside edges of the outer surface 46 of the bearing housing 34, prevents oil from leaking out between the bearing housing and the frame. Annular oil seal rings 54 located between the bearing housings 34 and the outer and inner axial retention plates 36 and 37, additionally prevent cooling oil leakage.

The perforation cylinder 12 is engaged and disengaged from contact with the anvil cylinder by rotating the eccentric bearing assembly 30. The inner axial retention plates 37, which are fixed to the bearing housing 34, comprise a toothed gear portion 39. The gears 39 are driven by throw-off gears 70, fixed to a throw-off shaft 66 that is rotatably mounted to the frame members 15 in bushings 67. The throw-off shaft 66 is rotated about its longitudinal axis 68 by linking member 62. A first end 61 of the linking member 62 is fixed to an end 69 of the shaft 66 extending outwards from one frame member 15. The linking member 62 also comprises, at an opposing second end 63, a pivotal joint 64 with a displaceable piston end 71 of a hydraulic cylinder 60. The opposing end of the hydraulic cylinder 60 is rotatably engaged with the frame by pivotal joint 65. Therefore, when the entire mechanism is actuated, the piston of the hydraulic cylinder extends upwards, imparting rotational motion to the linking member 62 about the axis 68 of the throw-off shaft 66. This results, through meshing gears 70 and 39, in a corresponding rotation of the bearing housing 34 in an opposite direction, thereby raising the perforation cylinder 12 away from contact with the anvil cylinder 14, as a result of the eccentric mounting of the perforation cylinder supporting bearings 32 within the bearing housing.

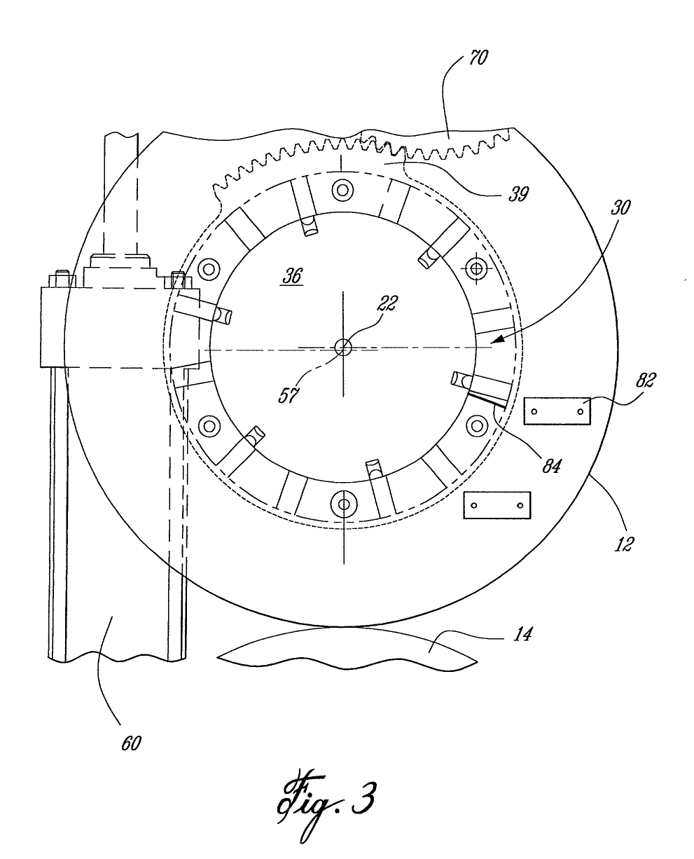

Referring to FIG. 3, visual indication of the position of the perforation cylinder is provided, namely indicating whether the perforation cylinder is in the lower position where the perforation blades are in contact with the anvil cylinder or whether the perforation cylinder is in the raised position where no perforation is being performed. A position identifying mark 84 is located on the exterior of at least one of the rotatable outer retention plates 36. Two radially spaced apart indicating marks 82 are located on the frame member 15, adjacent the outer retention plate 36, in pre-determined positions representative of the maximum travel points of the perforation cylinder 12.

Stops, either mechanical, hydraulic, or computer controlled, can be provided to limit the travel of the perforation cylinder, and to establish the precise pre-determined positions of the perforation cylinder for both perforation and thrown-off positions. Additionally, while the perforation throw-off mechanism actuation means is described above with respect to a hydraulic cylinder, it is equally possible to use other actuation means to rotate the throw-off shaft 66. These can include, but are not limited to, a manually operated lever mechanism, a pneumatic cylinder, an electric motor driven mechanism, and an electromagnetic driven system. Furthermore, it is also envisionable to use a combination of several such throw-off mechanism actuation means, in order to provide a fail-safe system, or to also permit the option of a manual override for example. All such systems can also be linked to a computer control system, either stand alone or integrated with a control system of the associated printing press, in order to control and monitor the perforation system as required. These can include a single touch screen control console, whereby the operator can remotely activate or disable the perforation system.

The activation of the perforation apparatus can also be automated, such that the computer controlled system can precisely engage and disengage the perforation cylinder at appropriate times, such as for example, during splicing of a new paper web roll. As creating perforations in a spliced portion of the paper web can cause a web tear and result in significant press downtime, the present perforation system permits suspension of the perforations until such time as the spliced portion of paper web has passed through the press. As such, it is possible for the operation of the present perforating apparatus to be automated by a computer controlled system to disengage, or “de-perf”, when an automatic splice detector senses a paper web splice, and be re-engaged when the splice detector indicates that the paper splice has passed through the apparatus. As the paper through speeds can be very high, such an automated system improves accuracy by eliminating the need for manual engagement and disengagement of the perforation system at precise times, and reduces the possibility of web tears which cause significant time and financial losses for the press operator.

1. A perforation forming apparatus for a web fed paper processor comprising:
a rotatable perforator cylinder comprising a longitudinal axis, and having at least a blade protruding radially from the perforator cylinder, extending axially therealong and being substantially parallel to the longitudinal axis;
a rotatable anvil cylinder being adjacent the perforator cylinder and contiguously engageable therewith, the anvil cylinder having a longitudinal axis of rotation parallel to the longitudinal axis of the perforator cylinder;
one of the perforator cylinder and the anvil cylinder being supported by eccentric bearing assemblies;
the eccentric bearing assemblies comprising fluid cooled bearings eccentrically mounted in bearing housings;
the eccentric bearing assemblies being adapted for rotation such that the one of the perforator cylinder and the anvil cylinder can be pivotally displaced between a first and a second position;
the first position defining a perforation position wherein the blade just contacts the anvil cylinder, and the second position defining a non-perforation position wherein a radial clearance gap between the blade and the anvil cylinder is at least equal to twice a thickness of a paper web adapted to be fed through the perforation forming apparatus;
whereby the one of the perforator cylinder and the anvil cylinder is displaceable to the second position during operation in order to temporarily suspend perforation of the paper web, and is returnable to the first position during operation in order to resume perforation of the paper web.

2. The perforation forming apparatus as defined in claim 1, wherein said bearings are pre-loaded.

3. The perforation forming apparatus as defined in claim 1, wherein the bearings are oil cooled.

4. The perforation forming apparatus as defined in claim 1, wherein the perforator cylinder assembly comprises a plurality of blades removably engaged to the perforator cylinder.

5. The perforation forming apparatus as defined in claim 1, wherein the bearing housings comprise passages therein adapted for cooling fluid flow.

6. The perforation forming apparatus as defined in claim 5, wherein the bearing housings comprise additional fluid sealing means.

7. The perforation forming apparatus as defined in claim 1, wherein the blade having a length substantially equal to a length of the perforator cylinder.

8. The perforation forming apparatus as defined in claim 1, wherein the anvil cylinder is supported by fluid cooled bearings.

9. The perforation forming apparatus as defined in claim 1, wherein at least one of the eccentric bearing assemblies is adapted for actuated rotation by an actuating means.

10. The perforation forming apparatus as defined in claim 9, wherein the actuating means can be remotely operated.

11. The perforation forming apparatus as defined in claim 9, wherein both eccentric bearing assemblies are adapted for simultaneous actuated rotation.

12. The perforation forming apparatus as defined in claim 1 wherein the eccentric bearing assemblies comprise visual position indication of the perforator cylinder position.

13. The perforation forming apparatus as defined in claim 1, wherein the apparatus is engaged with a web fed printing press, and whereby the apparatus can both temporarily suspend and resume perforation of the paper web at full printing press operating speed.

14. A method for controlling perforation of a paper web comprising the steps of:
providing a first rotatable cylinder having a longitudinal axis and comprising at least a blade, protruding radially from an outer axially extending circumferential surface of the first cylinder and extending axially therealong;
providing a second rotatable cylinder having a smooth outer axially extending circumferential surface and comprising a longitudinal axis of rotation parallel to the longitudinal axis of the first cylinder, the second cylinder being contiguously engageable with the first cylinder;
providing eccentric bearing assemblies for supporting one of the first and second cylinders, the bearing assemblies comprising fluid cooled bearings eccentrically mounted in rotatable bearing housings;
displacing the one of the first and second cylinders from a first to a second position, the first position defining a perforation position wherein the blade contacts the second cylinder and the second position defining a non-perforation position wherein a radial clearance gap between the blade and the smooth outer axially extending circumferential surface of the second cylinder is at least equal to twice a thickness of the paper web;
whereby displacing the one of the first and second cylinders to the second position suspends perforation of the paper web.

15. The method of temporarily suspending perforation as defined in claim 13, wherein the one of a first and second cylinders is returnable to the first position in order to resume perforation of the paper web.
